(19) United States
(12) Patent Application Publication
(10) Pub. No.: US 2007/0125913 A1
(43) Pub. Date: Jun. 7, 2007

(54) Removable mouse palm rest

(75) Inventors: Alana C. Miller, Kirkland, WA (US); Richard E. Compton, Lake Forest Park, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: Microsoft Corporation, Redmond, WA (US)

(21) Appl. No.: 11/293,272

(22) Filed: Dec. 5, 2005

(51) Int. Cl. B68G 5/00

(52) U.S. Cl. 248/118; 345/163

(57) ABSTRACT

The removable mouse palm rest includes a rearward end and a forward end. The palm rest includes a body portion, extending from the rearward end to the forward end, and may include a left and right arm member, extending from the body portion toward the forward end. The palm rest further includes a coupling system to removably couple the palm rest to a mouse with which it is being used. This removable mouse palm rest is particularly useful to expand the size and ease of use of a small sized mouse.

### BACKGROUND

Aspects of this invention relate to improving electronic mice for various environments. In recent years, the frequent travel of individuals has led to an emphasis on the development of computer equipment that is easily portable. Laptop or notebook computers are now commonly used in both business and home environments. These portable computing devices may have a cursor control device such as a built-in touch pad or pointing stick type mouse. While these built-in cursor control devices may be convenient because they are contained within the portable computer, they may be difficult to control, work with or may be uncomfortable for many users.

From the drawbacks associated with the use of the built-in cursor control devices arose the need for an external mouse of a smaller size that can be easily transported with a laptop or other portable computing device. These smaller sized mice provide the convenience of an external mouse, without the extra weight and large footprint of a typical full sized mouse.

While the smaller sized of the mouse is convenient for travel and for some small workspaces such as an airplane tray table, its smaller size may make it less comfortable and less ergonomic to use than a full size mouse. Despite the benefits of these smaller sized mice, improvements are possible.

### SUMMARY

In view of the foregoing, it would be useful to provide a mouse that is small, lightweight and portable, but may be expanded to the size of a full size mouse to provide the comfort level associated with a larger mouse. One aspect of the invention provides a removable mouse palm rest that may be attached to a small sized mouse to enlarge the footprint of the mouse to provide the comfort of a full size mouse.

Another aspect of the invention provides for a customizable mouse form through the use of multiple removable mouse palm rests. As in the previous embodiment, the palm rest may enlarge the footprint of the mouse to that of a full sized mouse. In addition, the removable palm rest may be offered in varying positions to allow for customization of the form or shape of the mouse. A left-handed, right-handed or center oriented palm rest may be used with the travel mouse to provide a customized fit for the user.

In an additional aspect of the invention, several different sized palm rests may be used to provide further customization for the individual user. A small, medium and large size palm rest could be used to account for differences in hand size between men and women or adults and children.

### BRIEF DESCRIPTION OF THE DRAWINGS

The present invention is illustrated by way of example and not limited in the accompanying figures in which like reference numerals indicate similar elements and in which:

FIG. 1 is a top view of a removable mouse palm rest and a mouse;

FIG. 2 is bottom view of the removable mouse palm rest;

FIG. 3A is a perspective view of the removable mouse palm rest shown coupled to a mouse;

FIG. 3B is a side view of the removable mouse palm rest shown coupled to a mouse;

FIG. 3C is a schematic cross section of the removable mouse palm rest shown coupled to a mouse;

FIG. 4 is a top view of the removable mouse palm rest and a side view of a mouse illustrating a coupling arrangement therebetween;

FIG. 5 is a top view of the removable mouse palm rest and a mouse showing an alternative coupling arrangement;

FIG. 6 is a top view of the removable mouse palm rest and a mouse showing another alternative coupling arrangement;

FIG. 7 is a schematic of the removable mouse palm rest and a mouse showing yet another alternative coupling arrangement;

FIG. 8 is a top view of a set of removable mouse palm rests;

FIG. 9 is a top view of an alternative set of removable mouse palm rests.

### DETAILED DESCRIPTION

The various aspects of the invention may be embodied in various forms. The following description shows by way of illustration various embodiments and configurations in which aspects of the invention may be practiced. It is understood that other embodiments may be utilized and structural and functional modifications may be made without departing from the scope of the present invention. For example, it is understood that embodiments of the invention may include one or more aspects of the invention described herein in various combinations.

As used herein, the term “travel type sized mouse” is herein defined as a computer mouse having a footprint of 4.0″ or less.

As used herein, the term “desk type sized mouse” is herein defined as a computer mouse having a footprint of 4.1″ or greater.

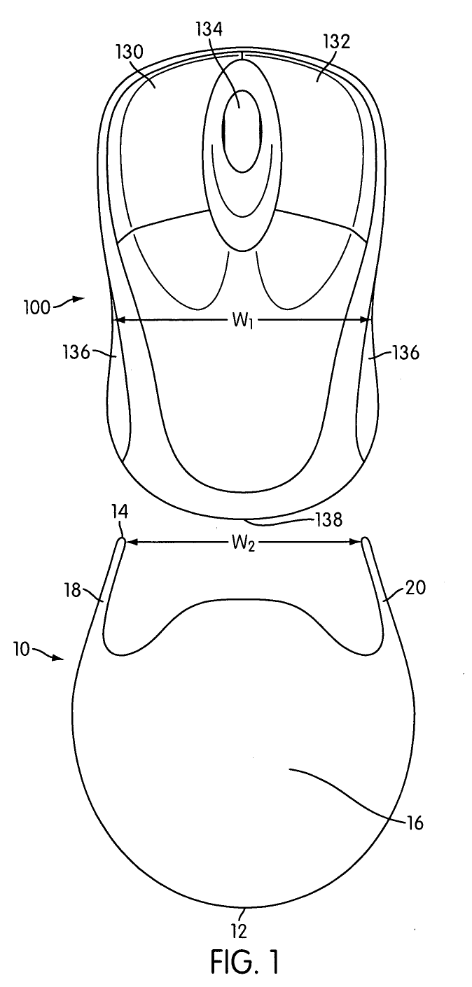

Several illustrative embodiments of a mouse with a removable mouse palm rest are shown in FIGS. 1-9. In one arrangement, the removable mouse palm rest is removably coupled to a travel type sized mouse and, when coupled converts the travel type sized mouse to a desk type sized mouse. The mouse depicted in the figures is but one example of a travel type sized mouse with which the invention may be used. Illustrations of that mouse are not intended to limit use of the invention to that particular mouse. Alternate arrangements and designs may be used.

FIGS. 1-9 illustrate various embodiments of the removable mouse palm rest 10 of the present invention. In one arrangement, the palm rest is of a one piece design and has a rearward end 12 being adjacent to the heel of the palm of the user, and a forward end 14 nearer to the fingers of the user. The palm rest may be formed from any suitable material, such as plastic, for example an ABS plastic material and may be formed using any suitable molding technique, e.g., injection molding. As shown, the palm rest 10 has a body portion 16, beginning at the rearward end 12 of the palm rest 10 and extending toward the forward end 14 a distance beyond the midpoint of the palm rest 10.

FIG. 1 illustrates the palm rest 10 as well as a mouse 100, to which the palm rest may be removably coupled. In one arrangement, the mouse 100 is a travel type sized mouse having a left or primary key 130, a right or secondary key 132 and a scroll wheel 134. The mouse 100 may include an ergonomically shaped body that includes an indented portion 136 on either side of the body of the mouse 100. Width, W1 defines an imaginary straight line connecting the narrowest points of the body of the mouse. Additionally, width W2 is shown as the narrowest point between the two arms of the palm rest 10. In one specific arrangement, mouse 100 has a footprint of four square inches (26 cm²) or less. In another specific arrangement, the mouse palm rest 10 adds an additional footprint of between 2 and 5 in² to the footprint of a mouse 100, such as a travel type sized mouse. In yet another arrangement, the mouse palm rest 10 adds an additional footprint of between 2.5 and 4 in² the footprint of a mouse 100.

In one exemplary arrangement, removable mouse palm rest 10 is removably coupled to mouse 100. The palm rest 10 may be coupled to the mouse 100 by sliding the palm rest 10 over the mouse 100 from the top. Alternatively, the mouse palm rest 10 may be coupled to the mouse 100 by sliding the forward end 14 of the palm rest 10 onto the rearward end 138 of the mouse 100. One the palm rest 10 is coupled to the mouse 100, it may be removed by sliding the palm rest 10 off the rearward end 138 of the mouse 100 or by sliding the palm rest 10 up off the top of the mouse 100.

In addition, the palm rest 10 may have a left arm member 18 and a right arm member 20 formed on each side of the body portion 16 and extending from the rearward end 12 of the body portion 16 toward the forward end 14 of the palm rest 10. The arm members provide for coupling to the mouse 100 and may have some flexibility. Each of the left and right arm members are curved inward, toward the body of the mouse 100 when coupled, to allow for a secure fit.

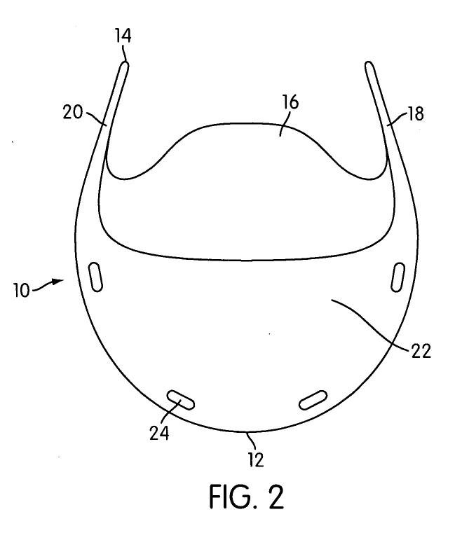

The palm rest 10 is ergonomically designed to comfortably fit the hand of the user. The exterior, top surface of the palm rest may have any number of finishes, e.g., padded, slick, to create a uniform surface between the palm rest and the mouse to which it is coupled. The bottom of the palm rest 22 may be open for a lightweight, hollow design. Alternatively, as shown in FIG. 2, the bottom 22 of the mouse palm rest 10 may be a flat base to provide a smooth surface on which the palm rest 10, when coupled to the mouse 100, may travel. As depicted, the bottom surface 22 may have pads 24 to provide a smooth surface on which the palm rest 10 may travel. Such pads are well known in the art.

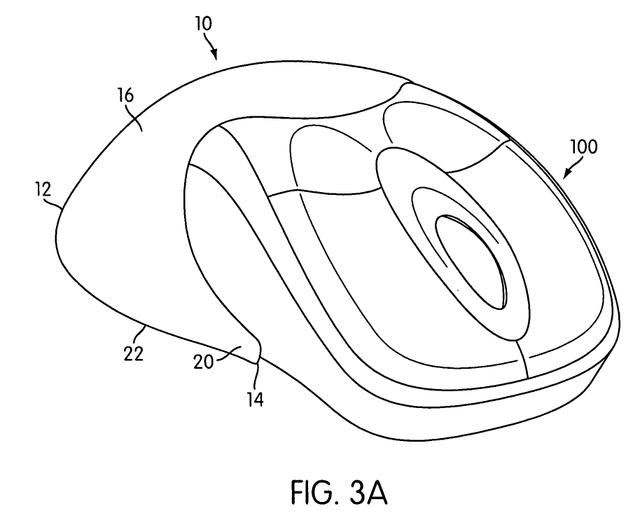

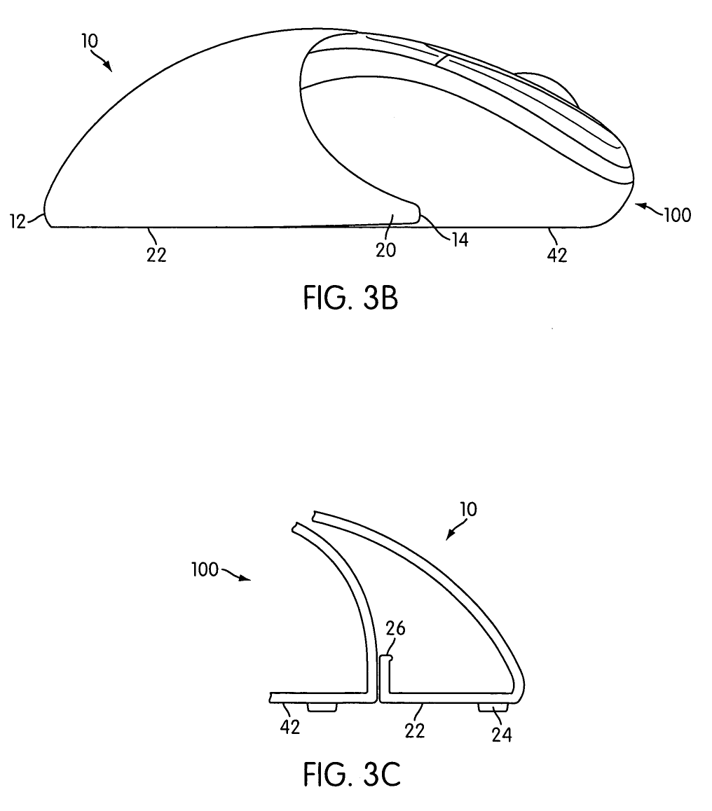

In one embodiment of the present invention shown in FIGS. 3A and 3B, the palm rest 10 removably couples to the mouse 100 by way of a bias fit arrangement. For example, the width of the mouse W1, as depicted in FIG. 1 is greater than the width of the palm rest W2, as depicted in FIG. 1. Accordingly, the palm rest 10 will remain attached to the mouse 100 due to this bias fit arrangement.

To attach the palm rest 10 to the mouse 100, the palm rest is placed adjacent to the rearward end 138 of the mouse 100 and slid forward over the body of the mouse until the bottom surface 22 of the palm rest 10 abuts the bottom surface 42 of the mouse 100. The flexibility of the arm members 18, 20 allows them to flex outward to fit around the wider portions of the mouse. When in its final coupled position, the arms 18, 20 of the palm rest 10 are in an outwardly biased position against the narrowest portion of the mouse body. Once coupled together, the top surfaces of the palm rest and mouse will form a substantially uniform surface. As illustrated in FIGS. 3A and 3B, the mouse 100 and palm rest 10 coupled together convert the mouse 100 from a travel type sized mouse to a desk type sized mouse. The mouse 100 and palm rest 10, when removably coupled, give the general appearance of being a desk type sized mouse and will function as such.

FIG. 3C depicts a cross section of the palm rest 10 removably coupled to the mouse 100. The pads 24 of the bottom surface 22 of the palm rest 10 are visible. In addition, slide stop 26, a raised abutment on the bottom surface 22 of the palm rest 10 is visible. In order to couple the palm rest 10 to the mouse 100, the palm rest 10 is slid forward over the rearward end 138 of the mouse 100 until the slide stop 26 abuts the rearward end 138 of the mouse 100.

In another embodiment of the present invention, the palm rest 10 and mouse 100 may be fitted with a snap fit arrangement. For example, the male portion of the snap fit may be located on the palm rest 10, while the female portion may be located on the mouse 100. Alternatively, the male portion may be located on the mouse 100 while the female portion is located on the palm rest 10.

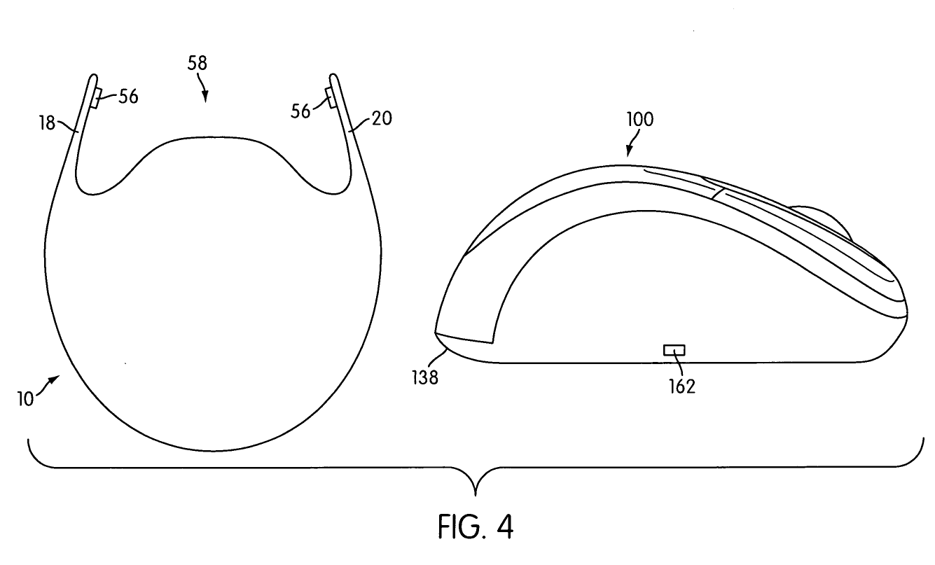

FIG. 4 depicts the palm rest 10 from a top view and the mouse 100 from a side view. In one arrangement, the male portion 56 of the snap fit arrangement is located on the palm rest 10. More particularly, each of the arm members 18, 20 has a male portion of a snap fit 56 protruding from the end toward the inner attaching area 58. The corresponding mouse 100 has a recess 162 or female portion of a snap fit, molded into each side of the mouse. The male portion 56 and female portion 162 are configured to align and removably couple the palm rest 10 to the mouse 100.

To couple the palm rest 10 to the mouse 100, the palm rest is adjacent to the rearward end 138 of the mouse 100. The palm rest 10 is slid forward around the body of the mouse 100, until the slide stop (shown in FIG. 3C) abuts the rearward end 138 of the mouse 100. The palm rest 10 may be flexible to fit around the broader portions of the mouse 100 when being coupled. When the slide stop abuts the rearward portion 138 of the mouse 100, the male portion 56 of the snap fit securely fits into the female recess 162 on each side of the mouse. The palm rest 10 and mouse 100 are removably coupled to convert a mouse, such as a travel type size mouse, to a desk type size mouse.

In an alternative embodiment not shown in the figures, the snap fit may be located on the bottom surface of the mouse. For instance, the female recess portions may be located on the bottom surface of the mouse. The male portions attached to the palm rest arm members, may protrude upward. The arm members may fit around the bottom edge of the mouse to snap the male portion of the fit into the recess in the bottom surface.

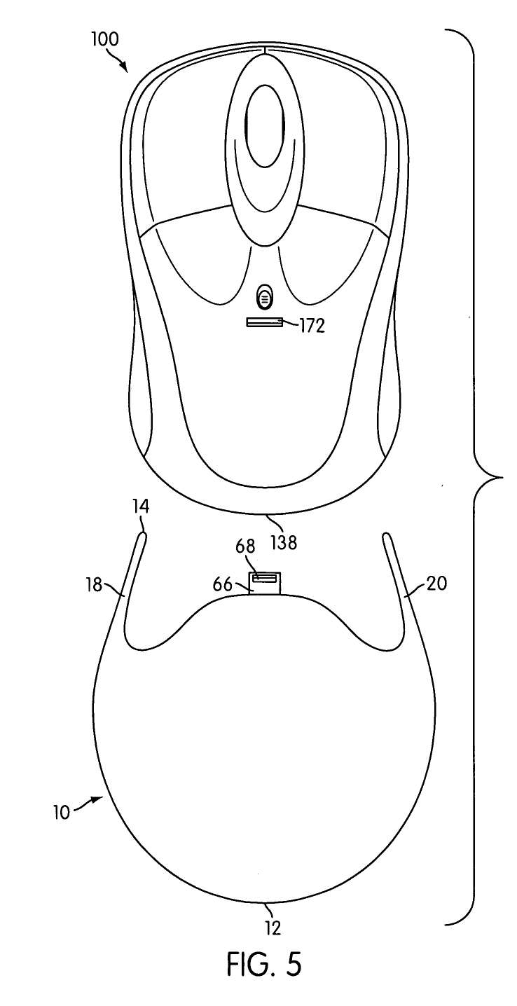

FIG. 5 depicts yet another embodiment of the present invention. The palm rest 10 of FIG. 5 is shown with a tab 66 in the center, protruding toward the forward end 12 of the palm rest 10. The tab 66 has a male portion 68 of a snap fit molded into it. The male portion 68 protrudes downward, toward the work surface.

To attach the palm rest of FIG. 5, the mouse 100 is configured with a recess 72 or female portion of a snap fit. The recess 72 may be molded into the top of the mouse 100. The recess 72 may have a cover (not shown) to snap into the recess 72 when the mouse is in use without the palm rest 10. The cover may be removed to allow the mouse recess 72 to receive the male portion 68 of the palm rest 10.

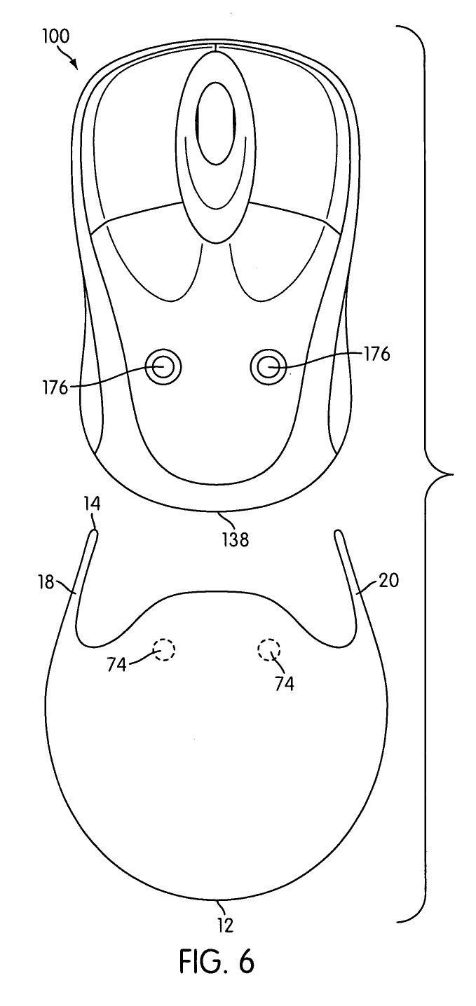

FIG. 6 illustrates an alternate embodiment of the palm rest 10. The palm rest 10 of this embodiment is shown with two buttons 74 molded into the underside of the palm rest 10 and protruding downward, toward the work surface. The buttons 74 are positioned on the underside of the body portion 16 of the palm rest 10 and are configured to fit into two recessed holes 176 within the mouse body. To attach the palm rest 10, the palm rest is placed adjacent to the rearward end X of the mouse 100 and slid forward until the slide stop (shown in FIG. 3C) abuts the rearward end 138 of the mouse 100. At that point, the buttons 74 may align with the recessed holes 176 and the palm rest 10 is securely and removably coupled to the mouse 100.

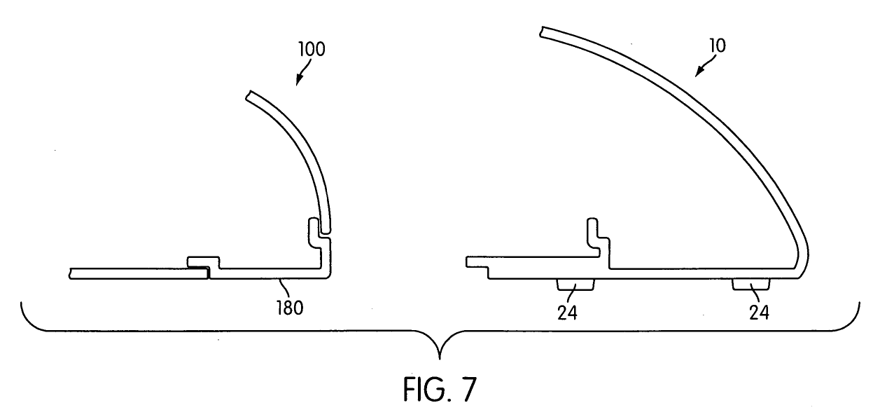

In yet another embodiment, FIG. 7 depicts the mouse palm rest 10 configured for coupling to mouse 100. In one arrangement, the palm rest 10 may be configured to couple to the mouse 100 by way of a removable battery housing cover panel 180, located at the bottom rearward portion of the mouse 100. In such an arrangement, the removable battery housing cover panel 180 may be removed and the palm rest 10 may be coupled to the mouse 100 by way of the battery housing cover opening. The mouse palm rest 10 may include a flange which serves as a cover for the battery housing, in the absence of the battery housing cover panel, when the palm rest 10 is coupled to the mouse 100.

In one embodiment, the palm rest may be sold as a kit with a mouse to which the palm rest may couple, as shown in FIGS. 1, 3A, 3B, 4, 5 and 6.

One potential advantage of the palm rest of the present invention is that it allows the user to customize the fit of palm rest to each user's individual needs. For instance, the palm rest could be molded to have the appropriate curvature of the palm rest body for either a left-handed or right-handed user. It could also be fabricated with a straight or center oriented body style to allow for use by either left or right-handed users.

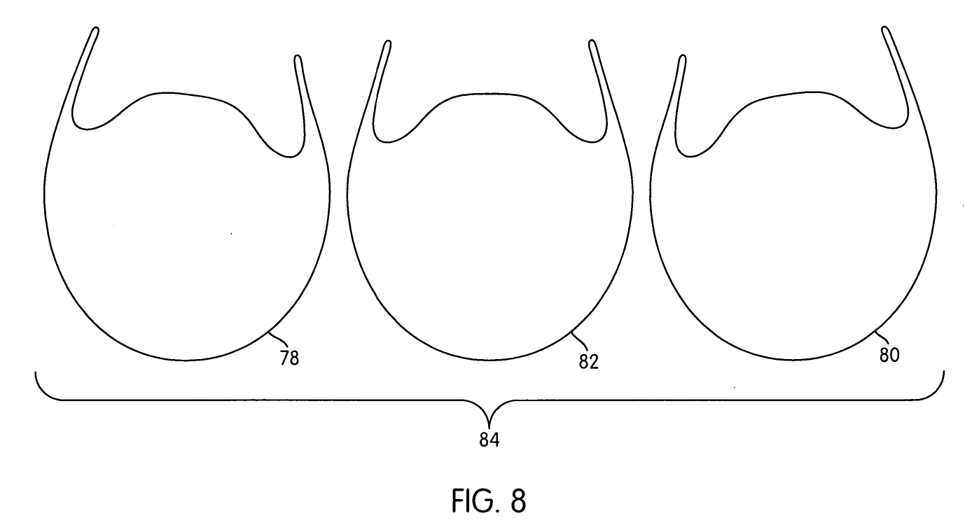

Each palm rest of the different orientations may be sold individually, or all three configurations of the palm rest may be sold together, as a kit. As shown in FIG. 8,

the kit 84 may include a left-handed palm rest 78, a right-handed palm rest 80 and a center oriented palm rest 82. Sale of all three configurations in a kit allows for customization of the same travel type sized mouse for various users. For instance, a family may use a mouse, such as a travel type sized mouse, coupled to the palm rest as their main mouse. This kit of three configurations would allow left-handed users and right-handed users to use the same mouse but customize the palm rest to each user's individual needs. Such a kit may also be sold with a mouse to which the palm rests may couple.

Another potential advantage of the palm rest of the present invention is that it may be customized to the user's size. The palm rest may be manufactured in a small size, a medium size and a large size. For instance, a family of users could use the same travel type sized mouse with their computer but have different palm rests to cater to the different hand sizes of the members of the family. A child is likely to have the smallest hand in the family and, as such may need the small size palm rest. A woman's hands may be smaller than a man's and, accordingly, the medium size palm rest may fit her. The large size may be needed by a man having large hands.

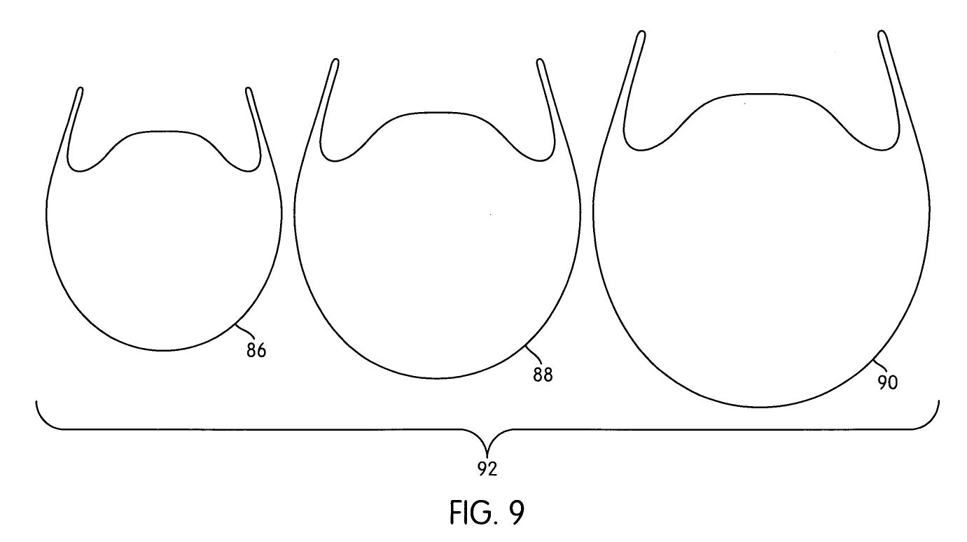

The different size palm rests may be sold individually or, to facilitate this advantageous use, the three sizes could be sold in a kit. As shown in FIG. 9, the kit 92 may include one of each of sizes small 86, medium 88 and large 90. Such a kit may also be sold with a mouse to which the palm rest may couple.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A mouse palm rest configured to be removably coupled to an electronic mouse, comprising:
a body portion configured to support a portion of a palm of a user during use; and
means for removably coupling the mouse palm rest to the electronic mouse.

2. The mouse palm rest of claim 1, wherein the mouse palm rest is sized and configured to convert a travel type sized mouse to a desk type sized mouse when coupled.

3. A kit including the mouse palm rest of claim 2, further including the electronic mouse.

4. The kit of claim 3, wherein the electronic mouse further includes a primary key, a secondary key and a scroll wheel.

5. The kit of claim 4, wherein the electronic mouse further includes a battery housing cover panel and the mouse palm rest further comprising a flange serving as a cover for the battery housing in the absence of the battery housing over when the mouse palm rest is coupled to the electronic mouse.

6. A kit including the mouse palm rest of claim 1, wherein the mouse palm rest is a first mouse palm rest, the kit further including a second palm rest being sized greater than the first mouse palm rest.

7. A kit including the mouse palm rest of claim 1, wherein the mouse palm rest is a first mouse palm rest of a symmetrical configuration, the kit further including a second mouse palm rest of an asymmetrical configuration.

8. A mouse palm rest configured to be removably coupled to an electronic mouse, comprising:
a rearward end and a forward end;
a body portion extending from the rearward end toward the forward end; and
a left and a right arm member, the left and right arm members extending from the body in a cantilevered manner and configured to apply an inwardly biasing force for coupling the mouse palm rest to the electronic mouse.

9. The mouse palm rest of claim 8, further including one of a male and female portion of a coupling system on the palm rest configured to couple with the other of a male and female portion located on the mouse.

10. The mouse palm rest of claim 9, wherein the mouse palm rest includes the male portion.

11. The mouse palm rest of claim 9, wherein the male portion is located on each of the respective arm members.

12. The mouse palm rest of claim 8, further comprising a coupling system having a bias fit arrangement.

13. The mouse palm rest of claim 8, further comprising a substantially planar base configured to rest on a supporting surface and adding an additional to the electronic mouse of between 2 and 4 inches.

14. The mouse palm rest of claim 8, wherein the mouse palm rest is sized and configured to convert a travel type sized mouse to a desk type sized mouse when coupled.

15. A mouse palm rest configured to be removably coupled to an electronic mouse, comprising:
a rearward end and a forward end;
a body portion extending from the rearward end toward the forward end; and
one of a male and female portion of a coupling system on the mouse palm rest configured to couple with the other of a male and female portion located on the mouse.

16. The mouse palm rest of claim 15 wherein the male portion is located on the mouse palm rest.

17. The mouse palm rest of claim 16, wherein the mouse palm rest includes spring elements configured to create a bias fit arrangement with the electronic mouse.

18. The mouse palm rest of claim 17, further comprising a substantially planar base and a raised abutment.

19. The mouse palm rest of claim 18, wherein the mouse palm rest is sized and configured to convert a travel type sized mouse to a desk type sized mouse when coupled.

20. The mouse palm rest of claim 19, wherein the mouse palm rest is asymmetrical to convert the travel type sized mouse to an asymmetrical desk type sized mouse to ergonomically fit into one of a left-handed or right-handed user's hand.
